(19) United States
(12) Patent Application Publication
(10) Pub. No.: US 2020/0324502 A1
(43) Pub. Date: Oct. 15, 2020

(54) TOOL INSTALLATION AID

(71) Applicant: Feintool International Holding AG, Lyss (CH)

(72) Inventor: Marc STAEMPFLI, Lyss (CH)

(73) Assignee: Feintool International Holding AG

(21) Appl. No.: 16/843,875

(22) Filed: Apr. 8, 2020

(30) Foreign Application Priority Data
Apr. 10, 2019 (EP) 19168429.9

(51) Int. Cl. B30B 15/02; B30B 11/24

(52) U.S. Cl. CPC B30B 15/026; B30B 11/241; B30B 15/028

(57) ABSTRACT

A tool installation aid for installing a tool into a press includes a holding console attachable to a press, and a tool-changing plate in or on which a tool is attachable, wherein the tool-changing plate can be placed onto a receiving element of the holding console, a drive device, drivable by a motor or manually, is disposed in the tool-changing plate and by way of which the tool-changing plate is displaceable on the receiving element in the direction toward the press to be transferred from the receiving element onto the clamping plate of the press, the drive device includes at least one driven first drive element, and the receiving element includes at least one non-driven second drive element, the first and second drive elements being operatively connected for displacing the tool-changing plate.

### BACKGROUND OF THE INVENTION

The invention relates to a tool installation aid for installing a tool into a press, and in particular a fine blanking press.

Such tool installation aids are essentially known from the prior art. These are used to transfer a tool of a press by way of a tool-changing plate, in or on which the tool is attached, into a press, and in particular onto a press table or the clamping plate of the press, so as to put the tool in the press into operation. This is provided, for example, when an existing tool is worn and has to be replaced with a new tool. In light of the considerable weight of the tools and the tool-changing plate, such a replacement cannot be carried out purely manually. Rather, a tool-changing plate is transferred from a region in front of the press into the press by way of a drive device, in particular a motor drive device, which displaces the tool-changing plate, in a horizontal plane, into the press.

According to the present state of the art, drive devices for transferring tool-changing plate are separate units, which are expensive and require a great deal of space in the region in front of the press. Such drive devices can be designed as motor-driven push link chains, which exert a pushing force on the tool-changing plate so as to displace this into the press, in particular onto the clamping plate thereof.

### SUMMARY OF THE INVENTION

In light of this described background, it is an object of the invention to provide a tool installation aid that can be of a less expensive design and requires less space, in particular no additional space at all, in a region in front of the press.

This object is achieved by a tool installation aid that comprises a holding console, which can be attached to the body/frame of a press and moreover comprises a tool-changing plate, in or on which a tool to be replaced can be attached, in particular in the recess of which a tool to be replaced can be inserted, wherein the tool-changing plate can be placed onto a receiving element of the holding console.

It may be provided in this regard that the receiving element, with a region supporting the tool-changing plate, is disposed in the same plane as the receiving plane of the clamping plate of the press onto which the tool is to be transferred, together with the tool-changing plate. According to the invention, the tool-changing plate can thus be transferred from the receiving element in the direction of, and onto, the clamping plate of the press, after the holding console has been attached to the press.

According to the invention, it is furthermore provided that a drive device, in particular a drive device drivable by a motor or manually, is disposed in the tool-changing plate, by way of which the tool-changing plate can be displaced on the receiving element, in particular transported in the direction toward the body/frame, and preferably can be transferred from the receiving element onto the clamping plate of the body/frame.

It is furthermore provided according to the invention that the drive device of the tool-changing plate comprises at least one driven first drive element, and the receiving element comprises at least one non-driven second drive element, which are operatively connected for displacing the tool-changing plate. Even though the second drive element itself is not driven so as to move the tool-changing plate, it is referred to as a drive element since it represents a part of the kinematic drive train that is used to move the tool-changing plate. The at least one second drive element is thus a passive element, which is idle, which is to say stationary, during the movement of the tool-changing plate.

A significant difference between the invention and the prior art is that the drive for moving the tool-changing plate is not separate from the tool-changing plate, but rather a drive device is integrated into the tool-changing plate in the invention. The aforementioned at least one first drive element can be driven in relation to the receiving element, in particular directly, by way of this drive device, for example when the drive device of the tool-changing plate already comprises a motor, or at least indirectly, for example when a motor is not integrated into the tool-changing plate, but is external in relation thereto.

In the latter case, indirect driving may take place, for example, in such a way that a driving force or a driving torque is transmitted to the tool-changing plate by an external motor, or by a manually actuatable element, for example by way of a coupling element on the tool-changing plate, wherein the drive device of the tool-changing plate is provided to transmit the force or the torque to the at least one first driven drive element. The drive device of the tool-changing plate can thus be designed as a force or torque transmission system, such as a gearbox, for transmitting a force or torque between the coupling element and the at least one first drive element.

The operative connection between the at least one driven first drive element and the non-driven at least one second drive element on the receiving element causes force or torque transmission between the tool-changing plate and the receiving element, so that the tool-changing plate can be moved relative to the receiving element, which is idle in relation to the press, as a result of this transmission.

Due to the at least partial integration of the drive device, which is to say, if necessary, excluding the motor or a manual actuating element, into the tool-changing plate, the requirements with regard to the necessary installation space for the drive device in front of the press are reduced.

Moreover, the complexity for the force transmission between the drive device and the tool-changing plate is reduced, since the components necessary therefor, in particular gearbox components, are included in the tool-changing plate. In particular, a motor for driving the tool-changing plate does not have to be disposed in a stationary manner with respect to the press since, in the invention, the force acting for the driving motion develops between the tool-changing plate and the receiving element, which, in turn, is connected to the press. The driving forces thus, in actuality, act directly between the tool-changing plate and the press. In this way, a motor can also be moved along with the tool-changing plate.

In a particularly preferred embodiment, the invention can provide that the at least one non-driven second drive element can be moved out of an idle position into a working position, wherein the at least one second drive element is only operatively connected to the at least one first drive element in the working position.

The idle and working positions are preferably positions assumed by the at least one second drive element on the receiving element. The drive element can be transferred between the two positions, for example, by way of a translatory and/or also rotatory movement relative to the receiving element. Since no operative connection is present between the at least one first and second drive elements in the idle position, this idle position may be intended, for example, for placing the tool-changing plate onto the receiving element, such that it is initially freely displaceable on the receiving element, in particular in the horizontal direction.

When the at least one second non-driven drive element is transferred from the idle position into the working position, the operative connection between the at least one first and second drive elements is established, and in particular these engage with one another in the process. The tool-changing plate is no longer freely displaceable thereafter, but is now displaceable with the integrated drive device thereof in the direction toward the press and away from the press.

In a preferred refinement, the invention can provide that at least one driven front first drive element and at least one driven rear first drive element, with respect to the displacement direction, in particular the direction toward the press, are disposed on the tool-changing plate, wherein the front and rear first drive elements are driven synchronously. The front and rear first drive elements are both part of the drive device of the tool-changing plate. In this way, the force or torque for moving the tool-changing plate on at least two driven first drive elements spaced apart from one another in the displacement direction can be transmitted to a non-driven second drive element, which, in particular, evenly distributes the force transmission to multiple locations.

This offers the advantage that it is possible to provide, in one refinement, that the at least one front first drive element and the at least one rear first drive element are simultaneously operatively connected to the same second drive element in a first displacement region, in particular an initial displacement region, and only the at least one rear first drive element is operatively connected to the second drive element in a second displacement region following the first in the displacement direction. During the transfer of the tool-changing plate, the at least one front first drive element can thus become disengaged from the second drive element, wherein driving continues to be ensured by way of the at least one rear first drive element. In this way, no force interruption occurs, even though the tool-changing plate moves out on the receiving element.

It is particularly advantageous when, in the second displacement region, the at least one front first drive element can be brought into operative connection with at least one third non-driven drive element on the press, and in particular, with the tool installation aid attached to a press, is operatively connected to at least one third non-driven drive element of the press.

During the transfer to the press, the front first drive element thus becomes disengaged from the second drive element and becomes operatively connected to a third non-driven drive element of the press, in particular while the at least one rear first drive element is continuously operatively connected to the second drive element.

It is further preferred that, in a third displacement region that follows the second displacement region in the displacement direction, the at least one front and rear first drive elements are not operatively connected to the at least one second drive element, and in particular in the third displacement region, with the tool installation aid attached to the press, the at least one front and rear first drive elements are simultaneously operatively connected to at least one third non-driven drive element on the press.

The tool-changing plate thus moves from the receiving element into the press, wherein the driving force is initially only supported on the receiving element, then on the receiving element and the press at the same time, and ultimately is only supported on the press.

The invention can preferably provide that at least one front and at least one rear first drive element are disposed in each case on the tool-changing plate, on each of the two side walls located opposite one another and extending parallel to the displacement direction, which, in particular, are operatively connected to at least one respective second drive element disposed on the receiving element along the respective side wall, for displacement.

In this way, the tool-changing plate can be moved particularly well in the desired displacement direction without tilting.

In an embodiment having a preferred design, the invention provides that the at least one first drive element is, and in particular the at least one front and rear first drive elements are, designed as a driven gear wheel, and the at least one second drive element, and in particular also the third drive element, is designed as a toothed rack in meshing engagement therewith.

In one possible design, the receiving element thus comprises two mutually opposing toothed racks as second non-driven drive elements, between which the tool-changing plate is disposed, wherein front and rear gear wheels, protruding in relation to the toothed rack and meshing therewith, are provided as the respective first driven drive element in a respective side wall of the tool-changing plate, which is located opposite a respective toothed rack. The driving forces are thus transmitted from the tool-changing plate to the outside on at least four points, initially only to the receiving element, then to the receiving element and the press, and thereafter only to the press. Toothed racks are disposed opposite one another in the press as the respective third drive element such that the toothed racks of the third and second drive elements are oriented so as to align with one another and are positioned synchronously in terms of the teeth.

The respective toothed rack of the second drive element can preferably be pivotable about a rotational axis, which is parallel to the displacement direction and parallel to the toothed rack extension, out of the idle position into the working position.

The driven front and rear gear wheels of the first drive elements on the two side walls of the tool-changing plate are, further preferably, each attached to a shared first drive shaft, and each first drive shaft is coupled, at the rear end thereof in the displacement direction, to a second drive shaft that is perpendicular thereto, in particular by way of bevel gears. Via a rotatable coupling element, which is disposed on an end wall of the tool-changing plate located perpendicularly to the side walls, a rotational movement, which is generated manually or by a motor, can be transmitted to the second drive shafts, in particular by way of a gear, such as an angular gear or worm gear. Using a motor attached to the coupling element or a crank handle, a rotation of all at least four gear wheels can be brought about, which are disposed at the front and rear, in the displacement direction, on a respective side wall of the tool-changing plate.

The receiving element can be attached, in an articulated manner, to support braces of the holding console. So as to attach the holding console to a press, the receiving element can, for example, be pivoted 90 degrees out of an initially parallel position between two preferably vertical support braces, and then be fixed, for example by fixing struts, which each extend between the lower end of the support brace and the end of the receiving element facing away from the press.

At the end facing the press, the receiving element can comprise attachment elements, which, in particular, protrude in the direction toward the press and which can engage in corresponding attachment elements of the press.

A preferred embodiment will be described in more detail based on the figures. All the figures show the same embodiment of the invention in different views, so that the figures overall are described hereafter collectively.

### BRIEF DESCRIPTION OF THE DRAWINGS

In the drawings:

FIG. 1a shows a perspective view of the tool installation aid on a press with the tool-changing plate in a starting position, and FIG. 1a′ and FIG. 1a″ show details of the tool installation aid enlarged relative to FIG. 1a;

FIG. 1b shows a perspective view of the tool installation aid on a press with the tool-changing plate in a transition position, and FIG. 1b′ and FIG. 1b″ show details of the tool installation aid enlarged relative to FIG. 1b;

FIG. 1c shows a perspective view of the tool installation aid on a press with the tool-changing plate in the end position;

FIG. 2a and FIG. 2b show, respectively, front and side elevation views of the tool installation aid on a press with the tool-changing plate in a starting position;

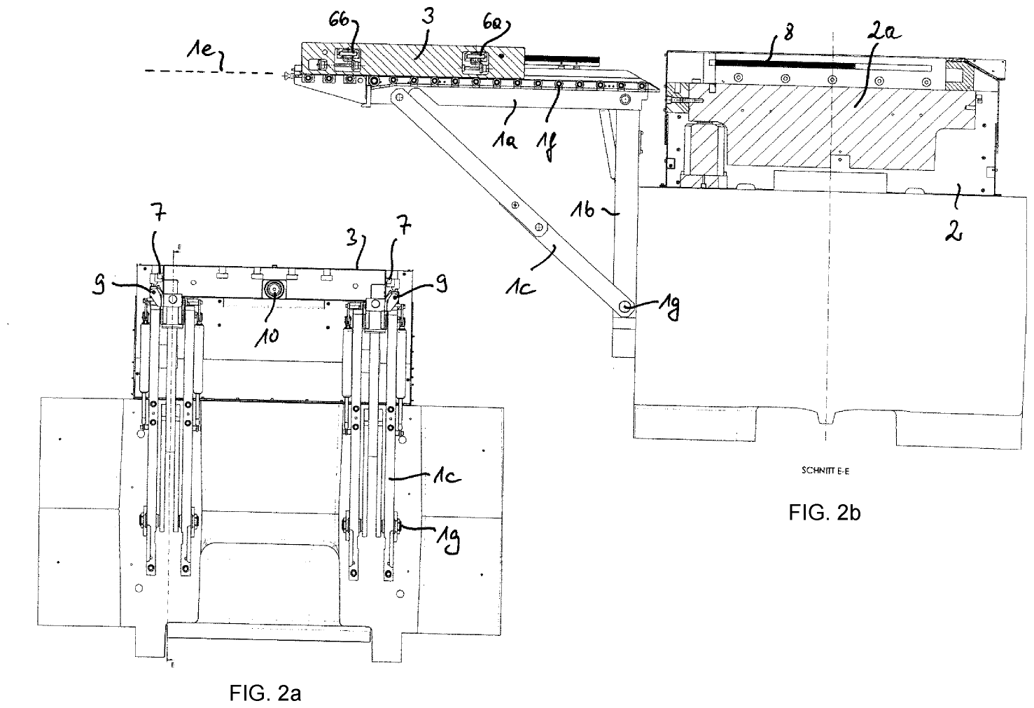

FIG. 3a shows the tool-changing plate without the tool, and FIG. 3a′ shows details of the tool-changing plate enlarged relative to FIG. 3a; and

FIG. 3b shows the tool-changing plate with the tool.

### DETAILED DESCRIPTION OF THE INVENTION

Shown is a tool installation aid, comprising a holding console 1, for a press, which is shown together with a portion of the press here.

The holding console 1 comprises two vertical support braces 1b, at the upper ends of which a receiving element 1a is attached in an articulated manner, so that the receiving element 1a can be folded out into the horizontal position shown here. The horizontal alignment of the receiving element 1a is secured by way of the fixing struts 1c. The holding console 1 is formed of the receiving element 1a, the support braces 1b and the fixing struts 1c.

The two vertical support braces 1b of the holding console 1 are fixedly connected to the press stand 2, i.e., the frame or body of the press. The receiving plane 1e can be aligned using the two eccentric bolts 1b, by way of which the fixing struts 1c are connected at the lower ends thereof to the support braces 1b. The receiving plane 1e is aligned with the plane of the press table or the clamping plate 2a. The receiving plane 1e here is the plane tangent to the upper extremity of the rollers 1f of the receiving element 1a. A tool-changing plate 3 can be moved on these rollers 1f in the direction toward the press stand 2.

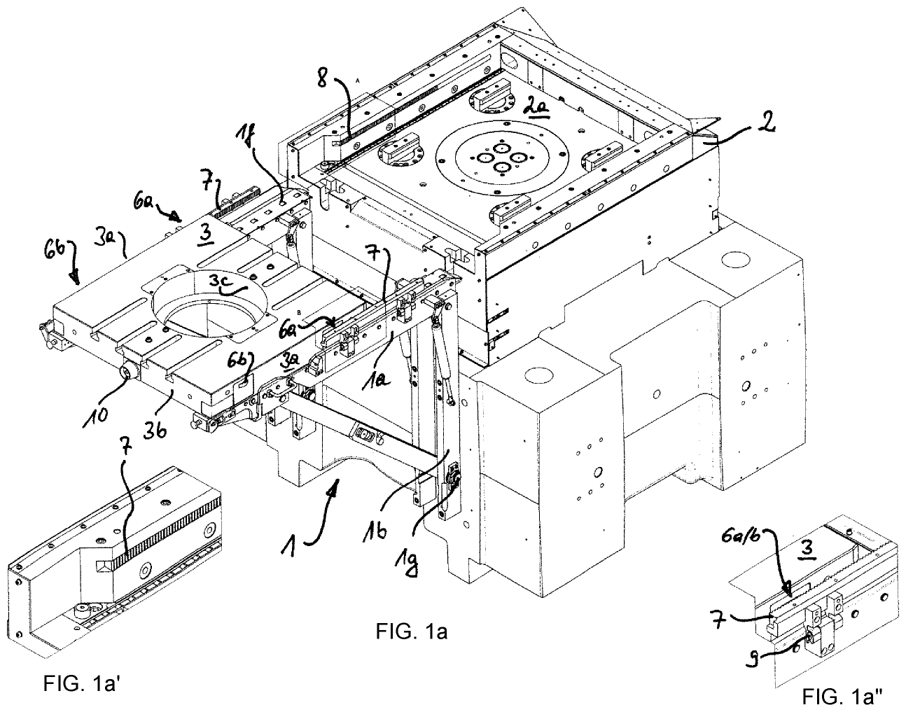

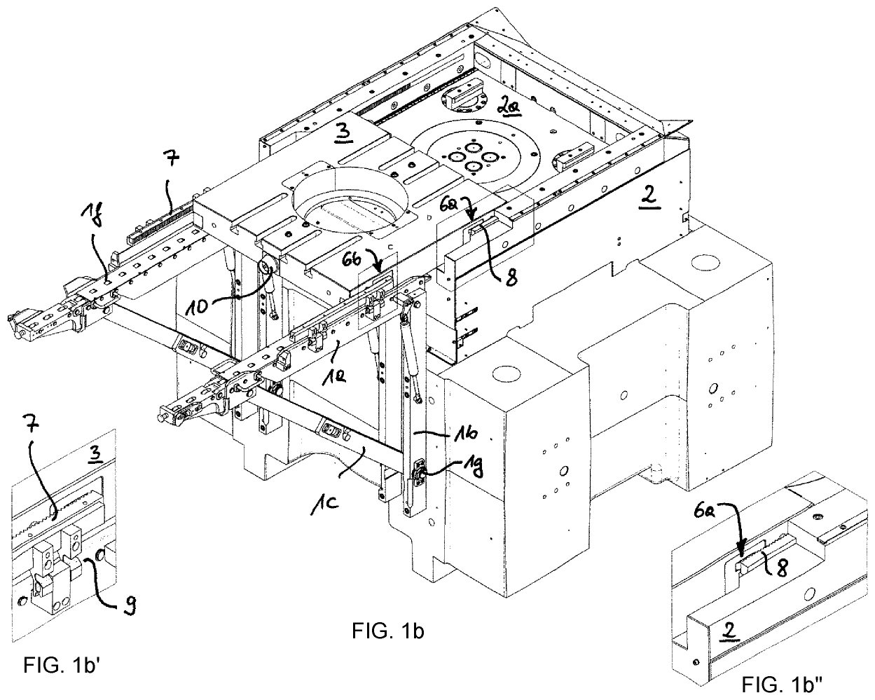

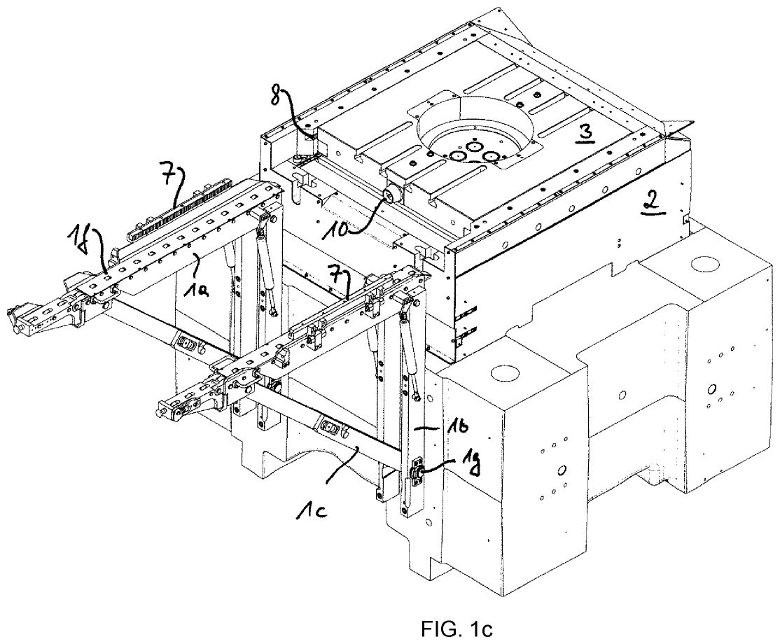

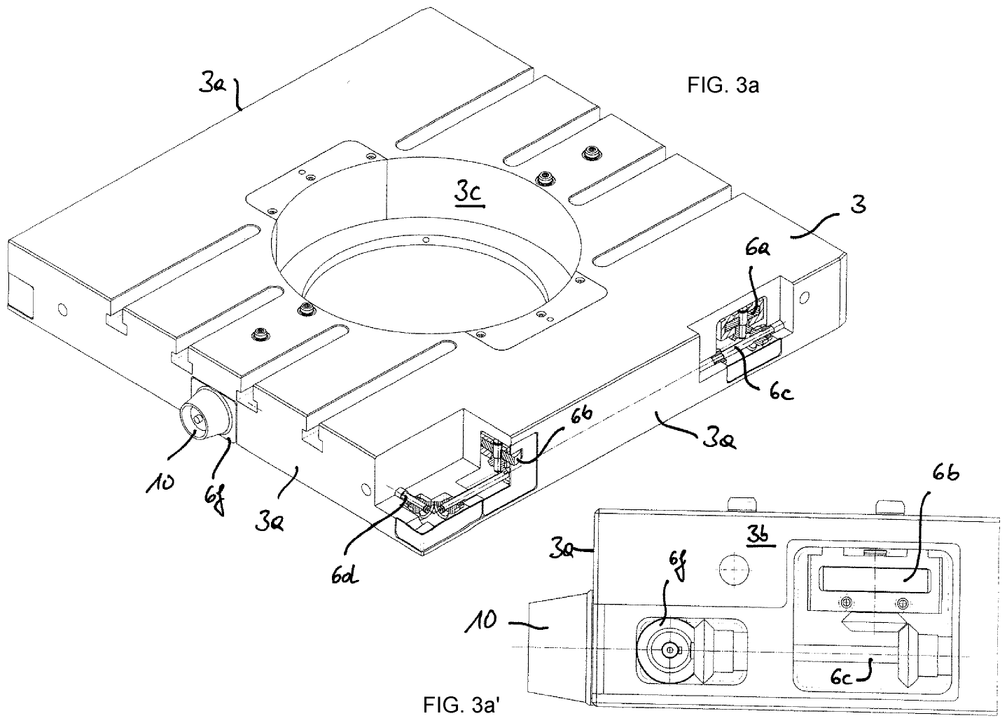

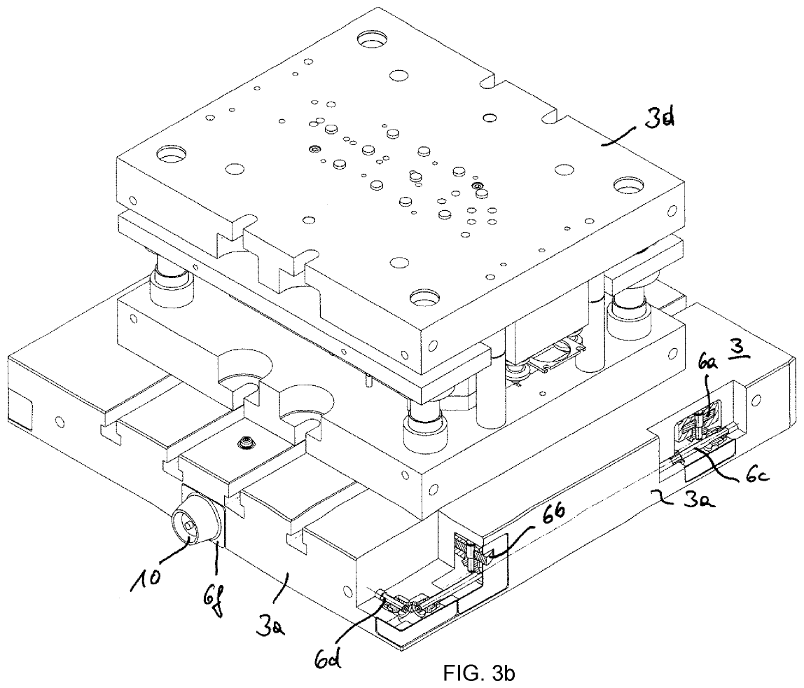

In the embodiment shown in FIGS. 1a, 1a′, 1a″, 1b, 1b′, 1b″, 1c, 2a, 2b, 3a and 3a′, the tool-changing plate 3 includes a recess 3c on, or via, which a tool can be attached, which is not shown in these figures. FIG. 3b, by way of example, shows the design of a possible tool 3d that is attached to the tool-changing plate 3 and, together with the same, can be moved into the press and out of the same.

Two gear wheels are disposed in each of the two side walls 3a of the tool-changing plate 3, wherein the gear wheel 6a is disposed at the front, and the gear wheel 6b is disposed at the rear, with respect to the displacement direction facing the press. The gear wheels 6a and 6b in each of the two side walls 3a thus form front and rear first driven drive elements. These are driven synchronously by the shafts 6c and 6d, which can be made to rotate by way of the coupling element 10 on the end face 3b facing away from the press 2. For this purpose, a crank handle or a motor can be applied to the coupling element, for example. The coupling element 10 comprises a gearbox 6f, which causes the two shafts 6d parallel to the end wall to rotate, which, in turn, drive the shafts 6c by way of bevel gears in the corners of the tool-changing plate 3.

Respective toothed racks 7, which are disposed on the receiving element 1a and can be pivoted there, about the rotational axes 9 between an idle position and a working position, extend parallel to the side walls 3a. In the working position, the gear wheels 6 mesh with the toothed racks 7. As a result of a rotation of the shaft in the coupling element 10, the gear wheels 6 can thus all be made to rotate synchronously, so that these can move forward, or backward, in the toothed racks 7, in the direction toward the press, and thereby move the tool-changing plate 3 forward or backward.

During a movement in the direction toward the press, the front gear wheels 6a become disengaged from the respective toothed racks 7 starting at a particular movement range, while the rear gear wheels 6b remain engaged and ensure the advancement. The front gear wheels 6a then become engaged with the toothed racks 8 on the press 2 above the clamping plate 2a, so that the driving force or the driving torque is transmitted directly onto the press. The associated position of the tool-changing plate is shown in FIG. 1b.

Thereafter, the rear gear wheels 6b become disengaged from the toothed racks 7, wherein further driving is thereafter carried out solely by way of the front gear wheels 6a, which are already meshing with the toothed racks 8. Thereafter, the rear gear wheels 6b also become engaged with the toothed racks 8. The end position achieved then is shown in FIG. 1c.

The described transfer of a tool, which is not shown, with the tool-changing plate 3 can also take place in the reverse direction and manner.

It is apparent from the figures that, except for the space for the holding console composed of support braces 1b, receiving element 1a and the fixing struts 1c, no additional space is required for a drive unit. A motor can be provided, for example, in a simple embodiment as a cordless screwdriver or compressed air motor having essentially no installation space requirement. A motor can also be configured as a drive secured by dual channels.

Compared to the prior art, the invention thus has a very compact design and is inexpensive to implement, since the essential components of the drive device are already integrated into the tool-changing plate, and the driving forces/torques act directly between the tool-changing plate and the receiving element or the press, and do not require any external support. Moreover, the receiving element 1a, when not needed, can be folded against the press frame 2 in a space-saving manner.

1. A tool installation aid for installing a tool into a press, comprising:
a holding console configured to be attached to a press;
a tool-changing plate configured to have attached therein or thereon a tool to be replaced can be transported to a table or clamping plate of the press, wherein the holding console comprises a receiving element configured to receive the tool-changing plate and the tool-changing plate is configured to be received by the receiving element,
a drive device disposed in the tool-changing plate and configured to be driven by a motor or manually to displace the tool-changing plate on the receiving element in a direction toward the press and transfer the tool-changing plate from the receiving element onto the table or clamping plate of the press, wherein
the drive device of the tool-changing plate comprises at least one driven first drive element, the receiving element comprises at least one non-driven second drive element, and the first and second drive elements are operatively connected for displacing the tool-changing plate in a direction toward the press.

2. The tool installation aid according to claim 1, wherein the at least one non-driven second drive element is configured to be moved between an idle position and a working position, the at least one non-driven second drive element being operatively connected to the at least one driven first drive element only in the working position.

3. A tool installation aid according to claim 2, wherein the at least one driven first drive element comprises at least one each of respective front and rear driven first drive elements, the at least one front and rear driven first drive elements being front and rear with respect to the displacement direction of the tool-changing plate toward the press and being configured to be driven synchronously.

4. The tool installation aid according to claim 3, wherein the at least one front driven first drive element and the at least one rear driven first drive element are configured to be simultaneously operatively connected to the at least one non-driven second drive elements in an initial region of displacement of the tool-changing plate in the direction of the press and for only the at least one rear first drive element to be operatively connected to the at least one non-driven second drive elements in a second displacement region following the first displacement region in the direction of displacement of the tool-changing plate.

5. The tool installation aid according to claim 4, wherein the holding console is attached to the press and the tool installation aid further comprises, on the press, at least one non-driven third drive element, wherein the at least one front driven first drive element is configured to be brought into operative connection with the at least one non-driven third drive element on the press.

6. The tool installation aid according to claim 5, wherein the at least one front and rear driven first drive elements are configured so that, in a third displacement region that follows the second displacement region in the direction of displacement of the tool-changing plate, the at least one front and rear driven first drive elements are not operatively connected to the at least one non-driven second drive element and are operatively connected to the at least one non-driven third drive element on the press.

7. The tool installation aid according to claim 1, wherein the at least one driven first drive element comprises, on each of opposite, mutually parallel side walls of the tool-changing plate, be respective at least one front and at least one rear driven first drive element, the at least one front and rear driven first drive elements being front and rear with respect to the displacement direction of the tool-changing plate toward the press, and wherein the at least one non-driven second drive element disposed on the receiving element comprises respective ones of the non-driven second drive elements extending parallel to the respective side walls.

8. The tool installation aid according to claim 3, wherein each of the at least one front and rear driven first drive elements comprises a respective driven front and rear gear wheel, and each of the at least one non-driven second drive element and the non-driven third drive element comprises a respective toothed rack configured for meshing engagement with the driven gear wheels.

9. The tool installation aid according to claim 8, wherein the toothed rack of each of the at least one non-driven second drive element is pivotable between the idle position and the working position about a rotational axis which is parallel to the displacement direction and parallel to a lengthwise direction of the toothed rack of the non-driven second drive element.

10. The tool installation aid according to claim 8, wherein the drive device of the tool-changing plate further comprises first and second drive shafts perpendicular to each other and respective bevel gears coupling each respective one of the first drive shafts, at a rear end thereof relative to the displacement direction, to a respective one of the second drive shafts, and the respective driven front and rear gear wheels of each respective one of the first drive elements are each attached to a respective one of the first drive shafts.

11. The tool installation aid according to claim 10, wherein the drive device further comprises a rotatable coupling element, the rotatable coupling element comprises a gearbox and is disposed on an end wall of the tool-changing plate, the end wall being perpendicular to the side walls and being at a rear end of the tool-changing plate relative to the displacement direction, the rotatable coupling element being configured so that a rotational movement, generated manually or by a motor and applied to rotate the rotatable coupling element, is transmitted to the second drive shafts by way of the gearbox.

12. The tool installation aid according to claim 1, wherein the holding console comprises articulated support members attached to the receiving element and configured to support the receiving element.

13. The tool installation aid according to claim 1, wherein the tool-changing plate comprises a recess configured for insertion therein of the tool to be transported to the table or clamping plate of the press.
